(19) United States
(12) Patent Application Publication
(10) Pub. No.: US 2012/0060421 A1
(43) Pub. Date: Mar. 15, 2012

(54) DOOR SAFETY DEVICE

(75) Inventor: Kam Fai WONG, Hong Kong (HK)

(73) Assignee: Design Lava Consultancy Company Limited

(21) Appl. No.: 13/170,186

(22) Filed: Jun. 28, 2011

(30) Foreign Application Priority Data
Sep. 14, 2010 (HK) 10108707.5

(51) Int. Cl. E06B 7/36

(52) U.S. Cl. 49/383

(57) ABSTRACT

A door safety device includes an elongated flexible member having an upper portion coupled to a hinge, a hinged edge of the door, or a door jamb at or proximate to a hinge axis. An object is fastened to a lower portion of the elongated flexible member. The object hangs from the elongated flexible member when the door is closed, and swings into a gap between the hinged edge of the door and the door jamb when the door is opened, thereby preventing closure of the door and accidental pinching of fingers of babies or infants in the gap. The object may be releasably held on a raised door stop portion of the door jamb.

### CROSS-REFERENCE TO RELATED APPLICATIONS

This application claims priority of Hong Kong short-term patent application No. 10108707.5 filed on Sep. 14, 2010, the entire content of which is hereby incorporated by reference.

### FIELD OF PATENT APPLICATION

The present application relates to a door safety device for the prevention of pinching of fingers or hands of babies and infants in the gap between a door jamb and a closing door.

### BACKGROUND

Every home is installed with a number of doors, such as the main door and the doors of the bedrooms, bathrooms, kitchen, etc. Each door assembly includes a door hingedly connected to a door jamb by a plurality of hinges. When a door is open, a gap is formed between the hinged side of the door and the door jamb. Curiosity drives babies and infants to insert their fingers and hands into the gap, or put their fingers and hands over the edges of the door or the door jamb. When the door is closed by a person or by a gust of wind, the fingers and the hands of the babies or infants may be caught and pinched between the door jamb and the closing door. This creates a hazardous environment for the babies and infants at home.

Existing door safety devices include the mounting of a large piece of finger guard around the gap between the door and the door jamb. These kinds of door safety device are complicated in structure, high in manufacturing cost and difficult to install.

Therefore, there is a need to produce an improved door safety device that is simple in construction, low in manufacturing cost and easy to install.

### SUMMARY

According to one aspect of the present application, there is provided a door safety device for a door assembly having a door hingedly connected to a door jamb by a plurality of hinges about a hinge axis. The door safety device includes an elongated flexible member having an upper portion coupled to the door assembly at or proximate to the hinge axis; an object fastened to a lower portion of the elongated flexible member; and an object-holding mechanism fastened to a raised door stop portion of the door jamb for releasably holding the object at a position where a portion of the object is disposed in the way of the door when being closed, wherein the object is pushed by the door, disengaged from the raised door stop portion of the door jamb, and hangs from the elongated flexible member when the door is closed, and swings into a gap between a hinged edge of the door and the door jamb when the door is opened, thereby preventing closure of the door and accidental pinching of fingers in the gap.

According to the embodiments, the elongated flexible member may be in the form of a string, a ribbon or a chain. The upper portion of the elongated flexible member may be coupled to one of the hinges. The upper portion of the elongated flexible member may be in the form of a loop adapted to be releasably hanged onto one of the hinges.

In one embodiment, the object is an elastic ball. The elastic ball may have a diametrically extending through hole through which the elongated flexible member is inserted. Two opposite ends of the elongated flexible member may pass through the through hole and tie into a knot at a lower end of the through hole, and a middle portion of the elongated flexible member may form a loop at an upper end of the through hole.

In one embodiment, the object-holding mechanism includes a magnet secured on one of the object and a support member fastened to the raised door stop portion of the door jamb, and an iron plate secured on the other one of the object and the support member.

According to another aspect of the present application, there is provided a door safety device for a door assembly having a door hingedly connected to a door jamb by a plurality of hinges about a hinge axis. The door safety device includes an elongated flexible member having an upper portion coupled to the door assembly at or proximate to the hinge axis; and an object fastened to a lower portion of the elongated flexible member, wherein the object hangs from the elongated flexible member when the door is closed, and swings into a gap between a hinged edge of the door and the door jamb when the door is opened, thereby preventing closure of the door and accidental pinching of fingers in the gap.

The door safety device may further include an object-holding mechanism fastened to a raised door stop portion of the door jamb for releasably holding the object at a position where a portion of the object is disposed in the way of the door when being closed; wherein the object is pushed by the door, disengaged from the door jamb, and hangs from the elongated flexible member when the door is closed.

According to the embodiments, the elongated flexible member may be in the form of a string, a ribbon or a chain. The upper portion of the elongated flexible member may be coupled to one of the hinges.

In one embodiment, the object is an elastic ball. The elastic ball may have a diametrically extending through hole through which the elongated flexible member is inserted. Two opposite ends of the elongated flexible member may pass through the through hole and tie into a knot at a lower end of the through hole, and a middle portion of the elongated flexible member may form a loop at an upper end of the through hole.

In one embodiment, the object-holding mechanism includes a magnet secured on one of the object and a support member fastened to the raised door stop portion of the door jamb, and an iron plate secured on the other one of the object and the support member.

Although the door safety device disclosed in the present application is shown and described with respect to certain embodiments, it is obvious that equivalents and modifications will occur to others skilled in the art upon the reading and understanding of the specification. The present application includes all such equivalents and modifications, and is limited only by the scope of the claims.

### BRIEF DESCRIPTION OF THE DRAWINGS

Specific embodiments of the door safety device disclosed in the present application will now be described by way of example with reference to the accompanying drawings wherein:

FIG. 1 is a top view of the door safety device according to one embodiment disclosed in the present application.

FIG. 2 is a front view of a magnetic support member of the door safety device according to one embodiment disclosed in the present application.

FIG. 3 shows an elastic ball hanging from an elongated flexible member of the door safety device according to three embodiments disclosed in the present application.

FIG. 4 is a cross sectional view of the elastic ball of FIG. 3.

FIG. 5 is a top view of the door safety device similar to FIG. 1 with the elastic ball being disposed between the hinged edge of the door and the door jamb.

FIGS. 6 and 7 show a top view of the door safety device according to another embodiment disclosed in the present application.

### DETAILED DESCRIPTION

Reference will now be made in detail to a preferred embodiment of the door safety device disclosed in the present application, examples of which are also provided in the following description. Exemplary embodiments of the door safety device disclosed in the present application are described in detail, although it will be apparent to those skilled in the relevant art that some features that are not particularly important to an understanding of the door safety device may not be shown for the sake of clarity.

Furthermore, it should be understood that the door safety device disclosed in the present application is not limited to the precise embodiments described below and that various changes and modifications thereof may be effected by one skilled in the art without departing from the spirit or scope of the appended claims. For example, elements and/or features of different illustrative embodiments may be combined with each other and/or substituted for each other within the scope of this disclosure and appended claims.

It should be noted that throughout the specification and claims herein, when one element is said to be “coupled” or “connected” to another, this does not necessarily mean that one element is fastened, secured, or otherwise attached to another element. Instead, the term “coupled” or “connected” means that one element is either connected directly or indirectly to another element, or is in mechanical or electrical communication with another element.

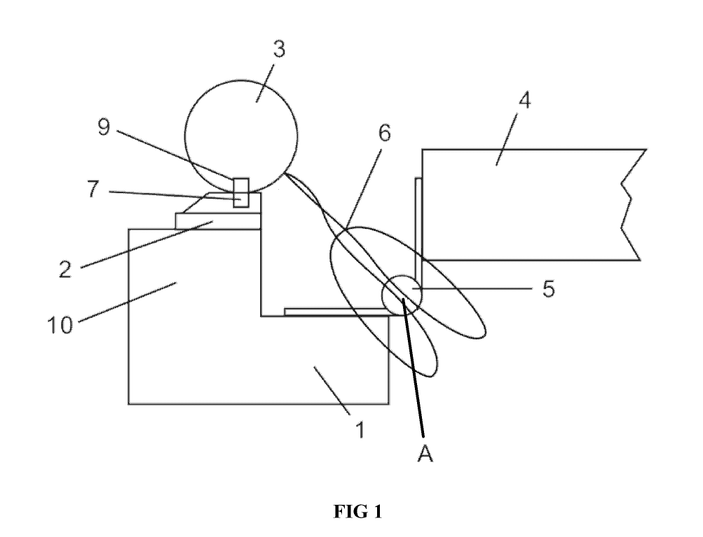

FIG. 1 shows a door safety device according to one embodiment disclosed in the present application. The door safety device is used in connection with a door assembly having a door 4 hingedly connected to a door jamb 1 by a plurality of hinges 5. A door jamb is the vertical side of a door frame to which a door is hinged. The door 4 is hingedly connected to the door jamb 1 and pivotable about a hinge axis A between a closed position and an opened position.

The door assembly may have two or more vertically spaced apart hinges 5. If the door assembly has two vertically spaced apart hinges 5, then the first hinge 5 can be located at an upper portion of the door 4 and the door jamb 1, and the second hinge 5 can be located at a lower portion of the door 4 and the door jamb 1. If the door assembly has three vertically spaced apart hinges 5, then the first hinge 5 can be located at an upper portion of the door 4 and the door jamb 1, the second hinge 5 can be located at a lower portion of the door 4 and the door jamb 1, and the third hinge 5 can be located at the middle portion of the door 4 and the door jamb 1. The hinges 5 can be a conventional leaf hinge having two knuckled leaf members, and a hinge pin inserted through interfitting apertured knuckles of the two knuckled leaf members.

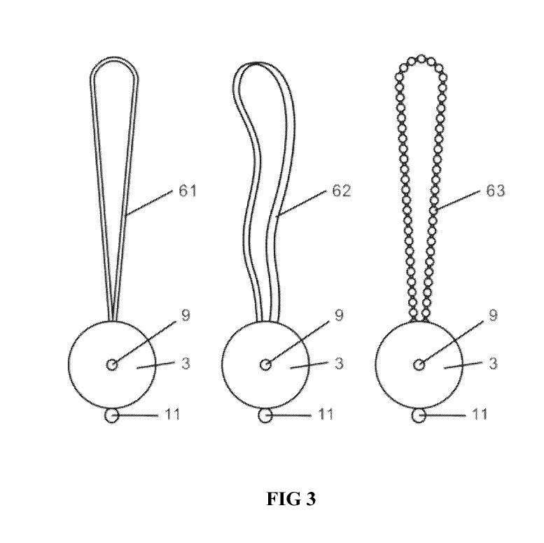

The door safety device may include an elongated flexible member 6 such as a string 61, a ribbon 62 or a chain 63, as shown in FIG. 3. The elongated flexible member 6 may have an upper portion and a lower portion. The upper portion of the elongated flexible member 6 can be coupled to one of the hinges 5 at or proximate to the hinge axis A, as depicted in FIG. 1. If the door assembly has two hinges 5, then the upper portion of the elongated flexible member 6 can be coupled to the hinge 5 located at the upper portion of the door 4 and the door jamb 1 where the door safety device can be disposed out of reach of a baby or an infant. If the door assembly has three hinges 5, then the upper portion of the elongated flexible member 6 can be coupled either to the hinge 5 located at the upper portion of the door 4 and the door jamb 1, or to the hinge 5 located at the middle portion of the door 4 and the door jamb 1.

Although it has been illustrated and described that the upper portion of the elongated flexible member 6 is coupled to one of the hinges 5 at or proximate to the hinge axis A, it is understood that the upper portion of the elongated flexible member 6 can be coupled to the hinged edge of the door 4, or the door jamb 1 proximate to the hinge axis A.

The upper portion of the elongated flexible member 6 can be coupled to the hinge 5, the hinged edge of the door 4, or the door jamb 1 by various possible means. According to the illustrated embodiment, the upper portion of the elongated flexible member 6 can be in the form of a loop and can be releasably hanged onto the pin of the hinge 5. The upper portion of the elongated flexible member 6 can also be coupled to the hinge 5, the hinged edge of the door 4, or the door jamb 1 by other means such as hook, adhesive tape, nail, screw, glue, etc.

The door safety device of the present application may further include an object 3 fastened to a lower portion of the elongated flexible member 6. According to the illustrated embodiment in FIG. 3, the object 3 can be in the form of an elastic ball. The elastic ball 3 may be made of rubber or other elastic material. The elastic ball 3 may have a size and elasticity sufficient to prevent closure of the door 4 when the door 4 is closed by a person or a gust of wind. The elasticity of the ball 3 can absorb the force of the closing door 4 that would otherwise damage the door assembly.

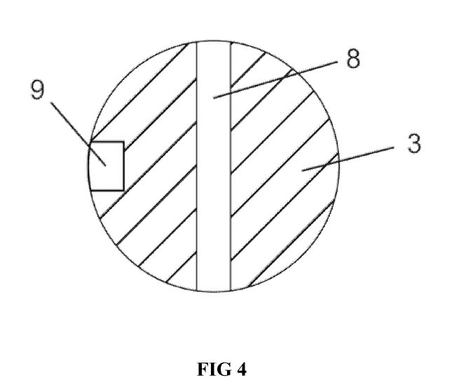

As illustrated in FIG. 4, the elastic ball 3 may have a diametrically extending through hole 8 through which the elongated flexible member 6 is inserted. According to the illustrated embodiment, the two opposite ends of the elongated flexible member 6 can be inserted through the through hole 8 and tied into a knot 11 at one end of the through hole 8, and a middle portion of the elongated flexible member 6 formed a loop at the other end of the through hole 8. The knot 11 has a dimension larger than the diameter of the lower end of the through hole 8 such that the elastic ball 3 can be held at the lower portion of the elongated flexible member 6, as depicted in FIG. 3.

Although it has been shown and described that the object 3 is secured to the lower portion of the elongated flexible member 6 by tying a knot 11, it is contemplated that the object 3 can be secured to the lower portion of the elongated flexible member 6 by other possible means such as the use of an adhesive tape, or glue, etc.

Furthermore, although it has been shown and described that the object 3 is an elastic ball, it is understood that the object 3 can be in the form of any object sized and shaped to prevent closure of the door 4 when it is moved from an opened position towards a closed position.

According to the illustrated embodiment, the object 3 may be releasably held to a raised door stop portion 10 of the door jamb 1 by an object-holding mechanism 2 at a position where a portion of the object 3 is disposed in the way of the door 4 when being closed. The object 3 can then be pushed by the door 4, disengaged from the door jamb 1, and hangs from the elongated flexible member 6 when the door 4 is closed, and swings into a gap between a hinged edge of the door 4 and the door jamb 1 when the door is open.

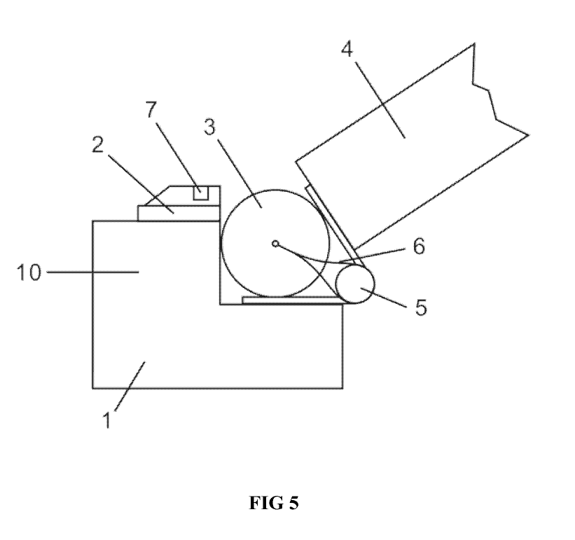

When the door 4 moves from the opened position towards the closed position, the hinged edge of the door 4 moves towards the door jamb 1 and pushes the object 3 against the door jamb 1 and the raised door stop portion 10 of the door jamb 1, as illustrated in FIG. 5. This can prevent closure of the door 4 and hence possible accidental pinching of fingers or hands of a baby or an infant in the gap between the door jamb 1 and the closing door 4.

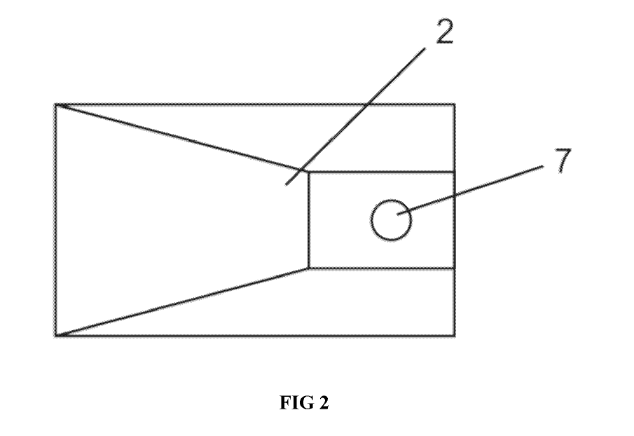

According to the illustrated embodiment, the object-holding mechanism may include a magnet 7 and an iron plate 9. The magnet 7 may be secured in a recess formed on a front surface of a support member 2, as best illustrated in FIG. 2. The support member 2 may be attached to the raised door stop portion 10 of the door jamb 1 by fastening means such as screws, nails, double-sided adhesive tapes, glue, or any other possible fastening means. The iron plate 9 may be secured in a recess formed on the elastic ball 3. It is of course contemplated that the magnet 7 can be secured to the elastic ball 3 and the iron plate 9 can be secured to the support member 2 instead.

Although it has been shown and described that the object 3 can be releasably held to the raised door stop portion 10 of the door jamb 1 by magnetic means, it is understood that the object 3 can be releasably held to the raised door stop portion 10 of the door jamb 1 by other possible mechanisms. For example, a double-sided adhesive tape can be adhered on the raised door stop portion 10 of the door jamb 1, and the object 3 can be releasably held to the raised door stop portion 10 of the door jamb 1 by the adhesive material provided on the adhesive tape. The object 3 can also be releasably held to the raised door stop portion 10 of the door jamb 1 by other methods such as hanging, hooking or supporting.

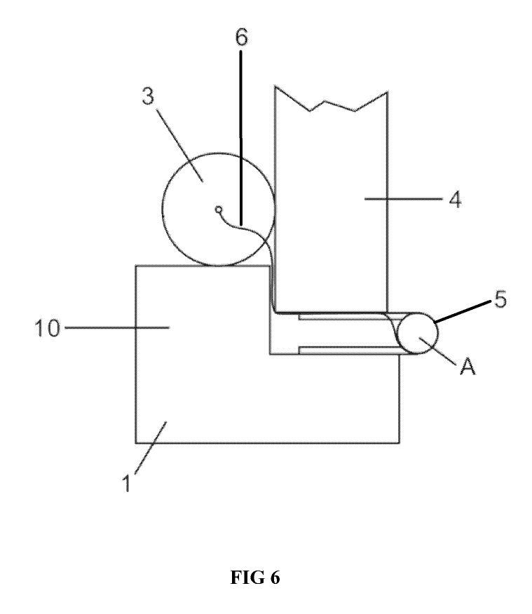

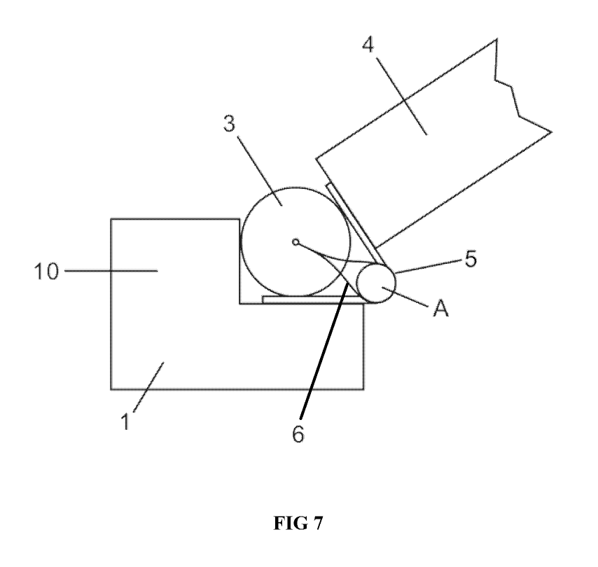

Although it has been shown and described that the door safety device in the present application includes an object-holding mechanism 2 for releasably holding the object 3, it is understood that the object 3 may simply be hanged on the elongated flexible member 6 when the door 4 is closed without being held by any object-holding mechanism, as illustrated in FIG. 6. The object 3 can then swing into the gap between the hinged edge of the door 4 and the door jamb 1 when the door is opened, as illustrated in FIG. 7.

While the door safety device disclosed in the present application has been shown and described with particular references to a number of preferred embodiments thereof, it should be noted that various other changes or modifications may be made without departing from the scope of the appending claims.

What is claimed is:

1. A door safety device for a door assembly having a door hingedly connected to a door jamb by a plurality of hinges about a hinge axis, the door safety device comprising:
an elongated flexible member having an upper portion coupled to the door assembly at or proximate to the hinge axis;
an object fastened to a lower portion of the elongated flexible member; and
an object-holding mechanism fastened to a raised door stop portion of the door jamb for releasably holding the object at a position where a portion of the object is disposed in the way of the door when being closed;
wherein the object is pushed by the door, disengaged from the raised door stop portion of the door jamb, and hangs from the elongated flexible member when the door is closed, and swings into a gap between a hinged edge of the door and the door jamb when the door is opened, thereby preventing closure of the door and accidental pinching of fingers in the gap.

2. The door safety device as claimed in claim 1, wherein the elongated flexible member is a string.

3. The door safety device as claimed in claim 1, wherein the elongated flexible member is a ribbon.

4. The door safety device as claimed in claim 1, wherein the elongated flexible member is a chain.

5. The door safety device as claimed in claim 1, wherein the upper portion of the elongated flexible member is coupled to one of the hinges.

6. The door safety device as claimed in claim 1, wherein the upper portion of the elongated flexible member is in the form of a loop adapted to be releasably hanged onto one of the hinges.

7. The door safety device as claimed in claim 1, wherein the object is an elastic ball.

8. The door safety device as claimed in claim 7, wherein the elastic ball has a diametrically extending through hole through which the elongated flexible member is inserted.

9. The door safety device as claimed in claim 8, wherein two opposite ends of the elongated flexible member passed through the through hole and tied into a knot at a lower end of the through hole, and a middle portion of the elongated flexible member formed a loop at an upper end of the through hole.

10. The door safety device as claimed in claim 1, wherein the object-holding mechanism comprises a magnet secured on one of the object and a support member fastened to the raised door stop portion of the door jamb, and an iron plate secured on the other one of the object and the support member.

11. A door safety device for a door assembly having a door hingedly connected to a door jamb by a plurality of hinges about a hinge axis, the door safety device comprising:
an elongated flexible member having an upper portion coupled to the door assembly at or proximate to the hinge axis; and
an object fastened to a lower portion of the elongated flexible member;
wherein the object hangs from the elongated flexible member when the door is closed, and swings into a gap between a hinged edge of the door and the door jamb when the door is opened, thereby preventing closure of the door and accidental pinching of fingers in the gap.

12. The door safety device as claimed in claim 11, further comprising an object-holding mechanism fastened to a raised door stop portion of the door jamb for releasably holding the object at a position where a portion of the object is disposed in the way of the door when being closed; wherein the object is pushed by the door, disengaged from the door jamb, and hangs from the elongated flexible member when the door is closed.

13. The door safety device as claimed in claim 11, wherein the elongated flexible member is a string.

14. The door safety device as claimed in claim 11, wherein the elongated flexible member is a ribbon.

15. The door safety device as claimed in claim 11, wherein the elongated flexible member is a chain.

16. The door safety device as claimed in claim 11, wherein the upper portion of the elongated flexible member is coupled to one of the hinges.

17. The door safety device as claimed in claim 11, wherein the object is an elastic ball.

18. The door safety device as claimed in claim 17, wherein the elastic ball has a diametrically extending through hole through which the elongated flexible member is inserted.

19. The door safety device as claimed in claim 18, wherein two opposite ends of the elongated flexible member passed through the through hole and tied into a knot at a lower end of the through hole, and a middle portion of the elongated flexible member formed a loop at an upper end of the through hole.

20. The door safety device as claimed in claim 11, wherein the object-holding mechanism comprises a magnet secured on one of the object and a support member fastened to the raised door stop portion of the door jamb, and an iron plate secured on the other one of the object and the support member.
